(19) United States
(12) Patent Application Publication
(10) Pub. No.: US 2024/0416927 A1
(43) Pub. Date: Dec. 19, 2024

(54) PHYSICAL QUANTITY DETECTING DEVICE

(71) Applicant: HITACHI ASTEMO, LTD., Hitachinaka-Shi, IBARAKI (JP)

(72) Inventors: Fumio YUKI, Hitachinaka-shi, Ibaraki (JP); Takeo HOSOKAWA, Hitachinaka-shi, Ibaraki (JP); Kenji YOSHIHARA, Hitachinaka-shi, Ibaraki (JP); Atsuo SOMA, Hitachinaka-shi, Ibaraki (JP); Hiroyuki ABE, Hitachinaka-shi, Ibaraki (JP)

(73) Assignee: HITACHI ASTEMO, LTD., Hitachinaka-Shi, IBARAKI (JP)

(21) Appl. No.: 18/702,944

(22) PCT Filed: Oct. 21, 2021
(86) PCT No.: PCT/JP2021/038899

§ 371 Date: Apr. 19, 2024

(51) Int. Cl. B60W 40/12; B60W 40/105

(52) U.S. Cl. CPC B60W 40/12; B60W 40/105; B60W 2420/225; B60W 2420/90; B60W 2422/70; B60W 2520/28; B60W 2530/20

(57) ABSTRACT

A physical quantity detecting device (10) detects a plurality of different physical quantities on the basis of an output signal waveform. A strain sensor (3) as one sensor element outputs a sensor signal waveform (15) having a reference level (151), a positive level positively changing from the reference level (151), and a negative level negatively changing from the reference level (151). An estimating unit (4) estimates a first physical quantity corresponding to a peak value (152) of the positive level and a second physical quantity corresponding to a peak value (153) of the negative level on the basis of the sensor signal waveform (15) output by the strain sensor (3).

### TECHNICAL FIELD

The present invention relates to a physical quantity detecting device.

### BACKGROUND ART

In recent years, toward a realization of automated driving, the development of a tire sensor technology has been actively under way, the tire sensor technology detecting the slipperiness of a road surface, a load weight applied to tires, and the like on the basis of information obtained from the tires in order to provide a safer traveling state. This is intended to prevent a tire trouble such as a burst due to an overload or an overturn of a vehicle due to a load imbalance, by providing the safer traveling state. The construction of such a safety control system necessitates accurate sensing of physical quantities such as the load weight and air pressure detected by the tires.

A strain sensor of a tire can detect a load weight acting on the tire and a wear amount of the tire by detecting a strain deformation of the tire. The prevention of vehicle troubles and an improvement in traveling safety by sensing traveling and road surface states are consequently expected.

On the other hand, the strain sensor may detect physical quantities (examples: velocity, temperature, the air pressure, the load weight, the wear amount, and the like) other than the load weight and the wear amount as mixed strain amounts at the same time. Hence, a sensor signal waveform indicating a result of the detection of a strain by the strain sensor may include components originating from these physical quantities. The components originating from these physical quantities other than the wear amount and the load weight decrease the accuracy of detection of the wear amount and the load weight.

As a conventional technology of such a detecting device, there is a technology described in Patent Document 1. Patent Document 1 describes a technology related to the strain sensor. Patent Document 1 describes a technology in which, with an object of “providing a method and a system that can estimate a load weight applied to a tire of a vehicle,” “a system and a method for estimating a load weight applied to a vehicle tire include: an air pressure measuring sensor attached to the tire to measure an air pressure level of a tire cavity; and one or two or more piezoelectric film deformation measuring sensors attached to a tire side wall(s). A deformation measuring sensor generates a deformation signal in a tire footprint, the deformation signal having a signal power level indicating a deformation level of the side wall in the vicinity of a footprint contact surface. A signal power versus load map associating load levels and signal power levels in predetermined ranges with each other, the signal power versus load map being corrected by tire air pressure, is generated and stored in order to be able to identify a load level from a signal power level on a tire air pressure corrected basis.

### PRIOR ART DOCUMENT

### Patent Document

Patent Document 1: JP-2014-054978-A

### SUMMARY OF THE INVENTION

### Problem to be Solved by the Invention

With the technology described in Patent Document 1, in view of a fact that a change in the tire air pressure changes the signal amplitude of a load sensor, the signal power level of the load sensor is corrected by using the tire air pressure measured by the air pressure measuring sensor. However, components originating from physical quantities other than the air pressure may be mixed in a detection signal of the load sensor. Hence, with the technology described in Patent Document 1, there is considered to be room for a further improvement in detection accuracy of the load sensor. In addition, no consideration is given to a technology that detects the load weight and another physical quantity together by using one sensor.

It is an object of the present invention to provide a physical quantity detecting device that detects a plurality of physical quantities together with high accuracy from a sensor signal waveform that is output by one sensor element and includes the plurality of physical quantities.

### Means for Solving the Problem

A physical quantity detecting device according to one aspect of the present invention is a physical quantity detecting device for detecting a plurality of different physical quantities on the basis of an output signal waveform, the physical quantity detecting device including: one sensor element that outputs a sensor signal waveform having a reference level, a positive level positively changing from the reference level, and a negative level negatively changing from the reference level; and an estimating unit that estimates a first physical quantity corresponding to a peak value of the positive level and a second physical quantity corresponding to a peak value of the negative level on the basis of the sensor signal waveform output by the sensor element.

### Advantages of the Invention

According to the present invention, it is possible to provide a physical quantity detecting device that detects a plurality of physical quantities together with high accuracy from a sensor signal waveform including the plurality of physical quantity output by one sensor element.

### BRIEF DESCRIPTION OF THE DRAWINGS

FIG. 1 is a configuration diagram illustrating a vehicle equipped with a physical quantity detecting device according to a first embodiment.

FIG. 2 is a configuration diagram illustrating the physical quantity detecting device according to the first embodiment.

FIG. 3A illustrates a strain sensor according to the first embodiment, and is a configuration diagram of the strain sensor.

FIG. 3B illustrates the strain sensor according to the first embodiment, and is an electric circuit diagram of the strain sensor.

FIG. 3C illustrates the strain sensor according to the first embodiment, and is a schematic diagram of output of the strain sensor.

FIG. 4 is a tire width direction vertical sectional view illustrating the disposition of the strain sensor according to the first embodiment.

FIG. 5 is a tire rotational direction vertical sectional view illustrating the disposition of the strain sensor according to the first embodiment.

FIG. 6 is an explanatory diagram illustrating a sensor signal waveform of the strain sensor, the sensor signal waveform corresponding to a rotational state of a tire according to the first embodiment.

FIG. 7 is a waveform chart illustrating the sensor signal waveform of the strain sensor, the sensor signal waveform corresponding to the rotational state of the tire according to the first embodiment.

FIG. 8 is an explanatory diagram illustrating the sensor signal waveform of the strain sensor in one cycle according to the first embodiment.

FIG. 9 is an explanatory diagram illustrating sensitivity to other parameters mixed in the sensor signal waveform of the strain sensor in one cycle according to the first embodiment.

FIG. 10 is an explanatory diagram illustrating changes in the output of the strain sensor in an initial state of the tire according to the first embodiment.

FIG. 11 is an explanatory diagram illustrating changes in the output of the strain sensor in a worn state of the tire according to the first embodiment.

FIG. 12A is an explanatory diagram illustrating changes in the output of the strain sensor at an air pressure of the tire according to the first embodiment, and is a section of the tire in a case of a proper air pressure.

FIG. 12B is an explanatory diagram illustrating changes in the output of the strain sensor at an air pressure of the tire according to the first embodiment, and is a section of the tire in a case of a low air pressure.

FIG. 12C is an explanatory diagram illustrating changes in the output of the strain sensor at an air pressure of the tire according to the first embodiment, and is a section of the tire in a case of a high air pressure.

FIG. 13 is a flowchart for deriving a first table of parameters mixed in the sensor signal waveform of the strain sensor according to the first embodiment.

FIG. 14 is an explanatory diagram illustrating the first table of the parameters mixed in the sensor signal waveform of the strain sensor according to the first embodiment.

FIG. 15 is an explanatory diagram illustrating a second table of parameters mixed in the sensor signal waveform of the strain sensor according to the first embodiment.

FIG. 16 is a flowchart for estimating a wear amount and a load weight of the tire from the sensor signal waveform of the strain sensor according to the first embodiment.

FIG. 17 is a diagram of assistance in explaining estimating the wear amount of the tire by applying the sensor signal waveform of the strain sensor according to the first embodiment to the first table.

FIG. 18 is a diagram of assistance in explaining estimating the load weight of the tire by applying the sensor signal waveform of the strain sensor according to the first embodiment to the second table.

FIG. 19 is an explanatory diagram illustrating a wear amount estimation result according to the first embodiment.

FIG. 20 is an explanatory diagram illustrating a load weight estimation result according to the first embodiment.

FIG. 21 is a configuration diagram illustrating a physical quantity detecting device according to a second embodiment.

FIG. 22 is an explanatory diagram illustrating an air pressure correlation table of the first table, the air pressure correlation table illustrating a correlation between a peak value of a positive level of the sensor signal waveform of the strain sensor according to the second embodiment and air pressure.

FIG. 23 is an explanatory diagram illustrating a velocity correlation table of the first table, the velocity correlation table illustrating a correlation between the peak value of the positive level of the sensor signal waveform of the strain sensor according to the second embodiment and velocity.

FIG. 24 is an explanatory diagram illustrating a temperature correlation table of the first table, the temperature correlation table illustrating a correlation between the peak value of the positive level of the sensor signal waveform of the strain sensor according to the second embodiment and temperature.

FIG. 25 is an explanatory diagram illustrating a load weight correlation table of the first table, the load weight correlation table illustrating a correlation between the peak value of the positive level of the sensor signal waveform of the strain sensor according to the second embodiment and a load weight.

FIG. 26 is an explanatory diagram illustrating the first table including various kinds of tables according to the second embodiment.

FIG. 27 is an explanatory diagram illustrating an air pressure correlation table of the second table, the air pressure correlation table illustrating a correlation between a peak value of a negative level of the sensor signal waveform of the strain sensor according to the second embodiment and the air pressure.

FIG. 28 is an explanatory diagram illustrating a velocity correlation table of the second table, the velocity correlation table illustrating a correlation between the peak value of the negative level of the sensor signal waveform of the strain sensor according to the second embodiment and the velocity.

FIG. 29 is an explanatory diagram illustrating a temperature correlation table of the second table, the temperature correlation table illustrating a correlation between the peak value of the negative level of the sensor signal waveform of the strain sensor according to the second embodiment and the temperature.

FIG. 30 is an explanatory diagram illustrating a wear amount correlation table of the second table, the wear amount correlation table illustrating a correlation between the peak value of the negative level of the sensor signal waveform of the strain sensor according to the second embodiment and a wear amount.

FIG. 31 is an explanatory diagram illustrating the second table including various kinds of tables according to the second embodiment.

FIG. 32 is a flowchart for estimating the wear amount and the load weight of the tire from the sensor signal waveform of the strain sensor according to the second embodiment.

FIG. 33 is a configuration diagram illustrating a wear amount processing part of a physical quantity detecting device according to a third embodiment.

FIG. 34 is a detailed configuration diagram illustrating a warning processing unit according to the third embodiment.

FIG. 35 is an explanatory diagram illustrating operation states of wear warnings according to the third embodiment.

### MODES FOR CARRYING OUT THE INVENTION

In the following, embodiments of the present invention are described with reference to the drawings. However, the present invention is not to be construed as limited to the following embodiments, but the technical concept of the present invention may be realized by combining publicly known other constituent elements. Incidentally, identical elements in the figures are identified by the same reference numerals, and repeated description thereof will be omitted.

### First Embodiment

### General Configuration of Vehicle

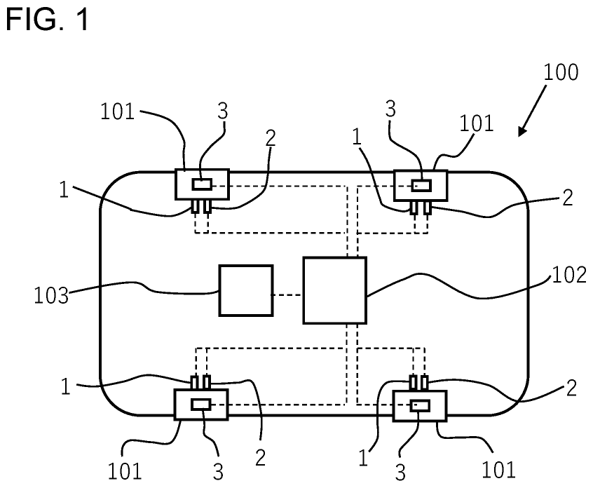

FIG. 1 is a configuration diagram illustrating a vehicle 100 equipped with a physical quantity detecting device 10 according to a first embodiment. As illustrated in FIG. 1, the vehicle 100 has four tires 101, one ECU 102, and one reporting unit 103. The vehicle 100 has four air pressure sensors 1, four temperature sensors 2, and four strain sensors 3. Incidentally, the vehicle 100 may be not only a two-wheeled vehicle or a four-wheeled vehicle that travels on a road surface 20 but also an airplane using a runway, a railway vehicle using tires, or the like.

The vehicle 100 travels on the road surface 20 by the rotation of the four tires 101. A human(s) board(s) the vehicle 100.

The tires 101 are set in ground contact with the road surface 20, and receive a load of the vehicle 100. The tires 101 rotate. The tires 101 are rubber members.

The ECU 102 is a control unit that controls the vehicle 100. The ECU 102 has an arithmetic processing unit, a storage unit, and input-output ports electrically connected to various kinds of sensors, the arithmetic processing unit such as a CPU, the storage unit such as a memory, and the reporting unit 103.

The reporting unit 103 is a monitor of a car navigation system. A display screen of the reporting unit 103 is switched to a car navigation screen, a wear amount report screen, and a load weight report screen by interrupt processing from the ECU 102. The display of the display screen of the reporting unit 103 is controlled under control of the ECU 102.

The air pressure sensors 1 obtain the air pressures of the respective tires 101, and output the air pressures to the ECU 102. The temperature sensors 2 obtain the temperatures of the respective tires 101, and output the temperatures to the ECU 102. The strain sensors 3 as sensor elements obtain sensor signal waveforms 15 in which various physical quantities are mixed in the respective tires 101, and the strain sensors 3 output the sensor signal waveforms 15 to the ECU 102.

### Physical Quantity Detecting Device 10

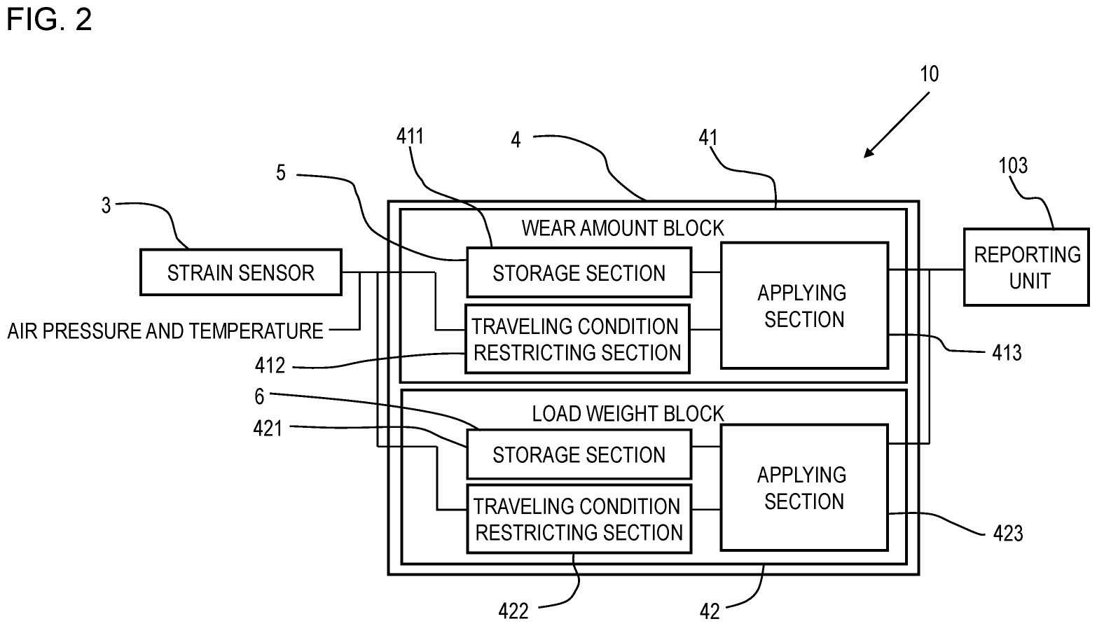

FIG. 2 is a configuration diagram illustrating the physical quantity detecting device 10 according to the first embodiment. The physical quantity detecting device 10 is related to a safe driving assistance device for the vehicle 100, and is, in particular, to prevent a tire trouble such as a burst due to an overload. The physical quantity detecting device 10 is a device that detects physical quantities acting on the tires 101 fitted to the vehicle 100.

As illustrated in FIG. 2, the physical quantity detecting device 10 includes the strain sensors 3, an estimating unit 4, and the reporting unit 103. The physical quantity detecting device 10 detects a plurality of different physical quantities on the basis of the output signal waveforms.

### Strain Sensor 3

The strain sensors 3 are sensor elements. The strain sensors 3 are semiconductors. The strain sensors 3 convert changes in resistance into corresponding strain amounts, and output the strain amounts. The strain sensors 3 are arranged one for each tire 101. The strain sensor 3 outputs a sensor signal waveform 15 that has a reference level 151, a positive level positively changing from the reference level 151, and a negative level negatively changing from the reference level 151. The strain sensor 3 detects a wear amount on the basis of a peak 152 of the positive level with respect to the unchanged reference level 151, and detects a load weight on the basis of a peak 153 of the negative level with respect to the unchanged reference level 151. The detection of both of the wear amount and the load weight together in one strain sensor 3 is thereby realized.

The strain sensor 3 outputs a strain amount by amplifying a small change in resistance. Even a resistance value that changes according to an environmental temperature affects the output value of the strain sensor 3, so that the output value is shifted from an original value. Hence, in order to detect the wear amount and the load weight with high accuracy, the strain amount that changes according to air pressure, velocity, temperature, and the like needs to be corrected. Incidentally, as for the temperature and the velocity, temperature and velocity information possessed by each vehicle 100 may be used without the sensors being newly provided. Information about the air pressure is obtained from the air pressure sensors 1.

The strain sensor 3 outputs the sensor signal waveform 15 under conditions of at least predetermined parameters such as the air pressure, the temperature, and the velocity obtained by the estimating unit 4.

### Estimating Unit 4

The estimating unit 4 exerts functions of the estimating unit 4 when a program within the ECU 102 is executed. The estimating unit 4 receives the sensor signal waveform 15 output by the strain sensor 3. The estimating unit 4 estimates the wear amount as a first physical quantity corresponding to the peak value 152 of the positive level and the load weight as a second physical quantity corresponding to the peak value 153 of the negative level on the basis of the sensor signal waveform 15 output by the strain sensor 3.

The estimating unit 4 obtains the air pressure of the tire 101 from the air pressure sensor 1. The estimating unit 4 obtains the temperature of the tire 101 from the temperature sensor 2. The estimating unit 4 obtains the velocity by dividing the outer circumference of the tire by an output cycle of the sensor signal waveform 15. Incidentally, the estimating unit 4 may obtain the velocity from a velocity sensor or the like. The estimating unit 4 estimates the wear amount and the load weight from the sensor signal waveform 15 output by the strain sensor 3 under the conditions of parameters such as the air pressure, the temperature, the velocity, the load weight, and the wear amount that are obtained by the estimating unit 4. The estimating unit 4 transmits the estimated wear amount and the estimated load weight to the reporting unit 103.

Here, the estimating unit 4 includes two independent blocks, that is, a wear amount block 41 and a load weight block 42 that respectively estimate the wear amount as the first physical quantity and the load weight as the second physical quantity.

### Wear Amount Block 41

The wear amount block 41 includes a storage section 411, a traveling condition restricting section 412, and an applying section 413.

The storage section 411 has a first table 5 of the first physical quantity corresponding to the peak value 152 of the positive level of the sensor signal waveform 15 output by the strain sensor 3.

The traveling condition restricting section 412 transmits the sensor signal waveform 15 of the strain sensor 3 to the applying section 413 when conditions under which the air pressure, the velocity, the temperature, and the load weight as parameters of mixed-in signals mixed in the sensor signal waveform 15 are restricted to predetermined ranges hold as conditions of predetermined parameters corresponding to the first table 5.

The applying section 413 estimates the wear amount as the first physical quantity by applying the peak value 152 of the positive level of the sensor signal waveform 15 output by the strain sensor 3 and transmitted by the traveling condition restricting section 412 to the first table 5 stored by the storage section 411. The applying section 413 transmits the estimated wear amount to the reporting unit 103.

### Load Weight Block 42

The load weight block 42 includes a storage section 421, a traveling condition restricting section 422, and an applying section 423.

The storage section 421 has a second table 6 of the second physical quantity corresponding to the peak value 153 of the negative level of the sensor signal waveform 15 output by the strain sensor 3.

The traveling condition restricting section 422 transmits the sensor signal waveform 15 of the strain sensor 3 to the applying section 423 when conditions under which the air pressure, the velocity, the temperature, and the wear amount as parameters of mixed-in signals mixed in the sensor signal waveform 15 are restricted to predetermined ranges hold as conditions of predetermined parameters corresponding to the second table 6.

The applying section 423 estimates the load weight as the second physical quantity by applying the peak value 153 of the negative level of the sensor signal waveform 15 output by the strain sensor 3 and transmitted by the traveling condition restricting section 422 to the second table 6 stored by the storage section 421. The applying section 423 transmits the estimated load weight to the reporting unit 103.

### Details of Strain Sensor 3

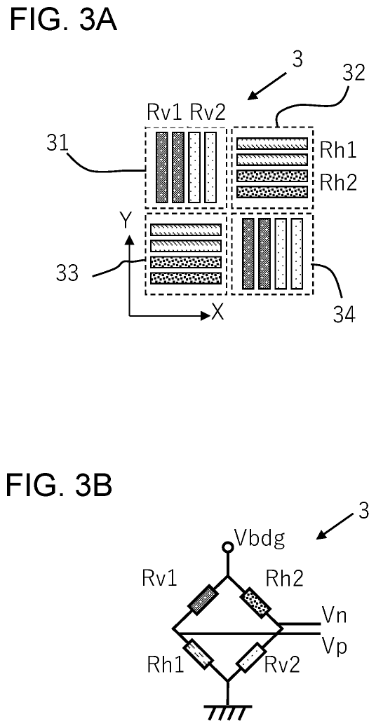

FIGS. 3A to 3C illustrate the strain sensor 3 according to the first embodiment. FIG. 3A is a configuration diagram of the strain sensor 3. FIG. 3B is an electric circuit diagram of the strain sensor 3. FIG. 3C is a schematic diagram of output of the strain sensor 3.

As illustrated in FIG. 3A, the strain sensor 3 includes a plurality of detecting units 31 to 34 arranged in a plurality of rows and a plurality of columns in an X-direction and a Y-direction orthogonal to each other. In this case, the strain sensor 3 includes four detecting units 31 to 34 arranged in two rows and two columns in the X-direction and the Y-direction orthogonal to each other.

The strain sensor 3 utilizes a piezoresistance effect, and measures changes in resistivity of piezoresistances as an electric signal. The strain sensor 3 is formed by a silicon chip of 2.5 mm square. The piezoresistances are disposed in a gage region at a center of the sensor chip of the strain sensor 3.

As illustrated in FIG. 3B, a Wheatstone bridge circuit constituted by piezoresistances Rv1, Rv2, Rh1, and Rh2 as two detecting units 31 and 32 is formed within the gage region. The piezoresistances are formed by ion implantation, and are adjusted so as to have a uniform initial resistance and a uniform piezoresistance coefficient. The strain sensor 3 has detection axes in the X-direction and the Y-direction of sides of the chip. The strain sensor 3 changes an output voltage thereof in proportion to a strain applied in the X-direction or the Y-direction of the chip. In the strain sensor 3, same strains occur in the X-direction and the Y-direction. The strain sensor 3 does not produce an output in response to a simple shear strain or an isotropic strain. When strains in the X-direction and the Y-direction are different from each other, the strain sensor 3 produces an output proportional to a difference (Vp−Vn) between the two strains. The piezoresistances change output polarity according to the direction of a strain on an XY plane.

As illustrated in FIG. 3C, when the plane is warped such that a sensor surface expands in the X-direction, for example, the resistances of Rh2 and Rh1 increase. Thus, a Vp output increases, a Vn output decreases, and the output of Vp−Vn becomes a positive output. When the plane is warped such that the sensor surface is compressed in the X-direction, in contrast, the resistances of Rh2 and Rh1 decrease. Thus, the Vp output decreases, the Vn output increases, and the output of Vp−Vn becomes a negative output.

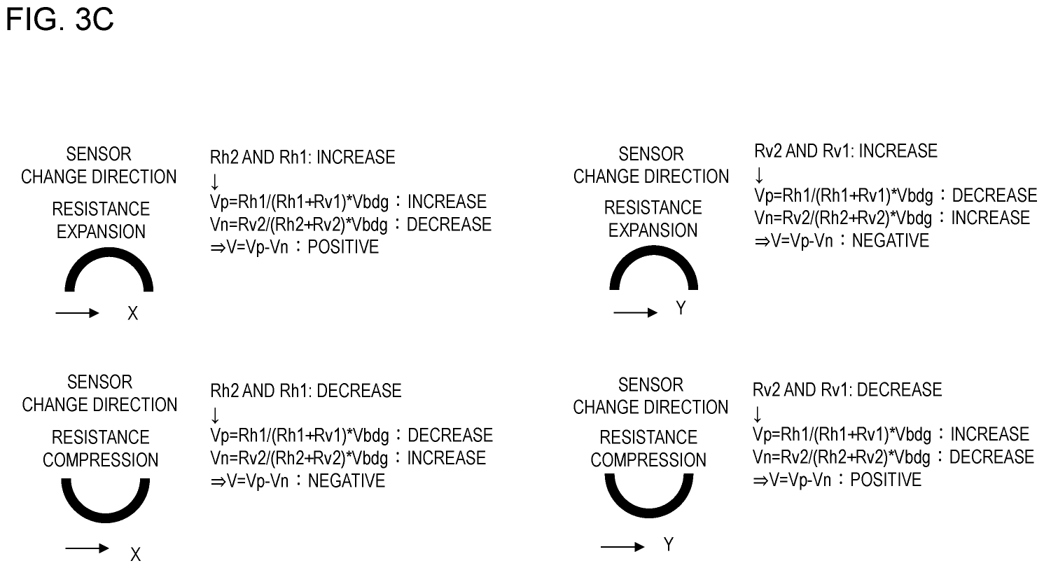

FIG. 4 is a tire width direction vertical sectional view illustrating the disposition of the strain sensor 3 according to the first embodiment. As illustrated in FIG. 4, the strain sensor 3 is disposed at a center in a tire width direction on an inner circumferential side of the tire 101. The strain sensor 3 is disposed in the tire 101 such that the Y-direction in which the two detecting units 31 and 32 and the two detecting units 33 and 34 are respectively arranged side by side to produce output is set along the width direction of the tire 101.

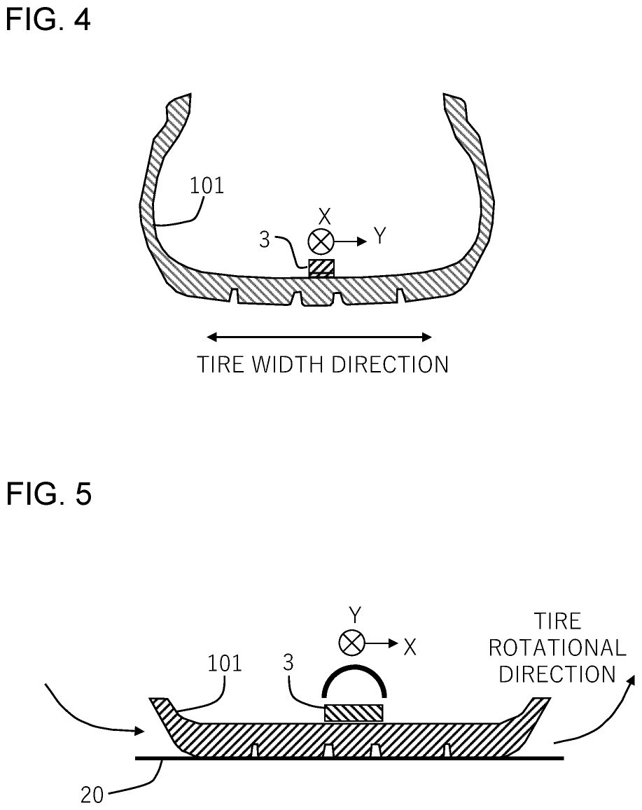

FIG. 5 is a tire rotational direction vertical sectional view illustrating the disposition of the strain sensor 3 according to the first embodiment. As illustrated in FIG. 5, the strain sensor 3 is disposed in the tire 101 such that the X-direction in which the two detecting units 31 and 33 and the two detecting units 32 and 34 are respectively arranged side by side to produce output is set along a rotational direction.

### Sensor Signal Waveform 15

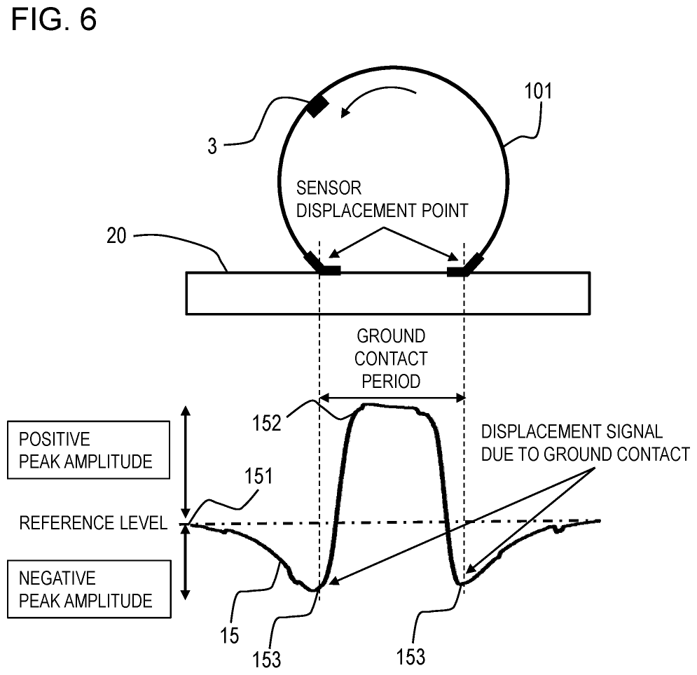

FIG. 6 is an explanatory diagram illustrating the sensor signal waveform 15 of the strain sensor 3, the sensor signal waveform 15 corresponding to a rotational state of the tire 101 according to the first embodiment. As illustrated in FIG. 6, the strain sensor 3 disposed within the tire 101 outputs the sensor signal waveform 15 that changes according to the state of the tire 101 that rotates.

The strain sensor 3 outputs the sensor signal waveform 15 having the reference level 151, the positive level positively changing from the reference level 151, and the negative level negatively changing from the reference level 151.

The strain sensor 3 maintains the reference level 151 of the sensor signal waveform 15 when the strain sensor 3 is not in ground contact. The strain sensor 3 outputs the peak value 152 of the positive level of the sensor signal waveform 15 in a state in which the tire 101 is in ground contact with the road surface 20. The strain sensor 3 outputs the peak value 153 of the negative level of the sensor signal waveform 15 at a moment that the tire 101 comes into ground contact with or separates from the road surface 20. Here, the moment at which the tire 101 comes into ground contact with or separates from the road surface 20 is a sensor displacement point. A period between two sensor displacement points is a ground contact period during which the tire 101 is in ground contact with the road surface 20.

The thus detected sensor signal waveform 15 changes according to various physical quantities (the wear amount, the load weight, the air pressure, the velocity, and the temperature).

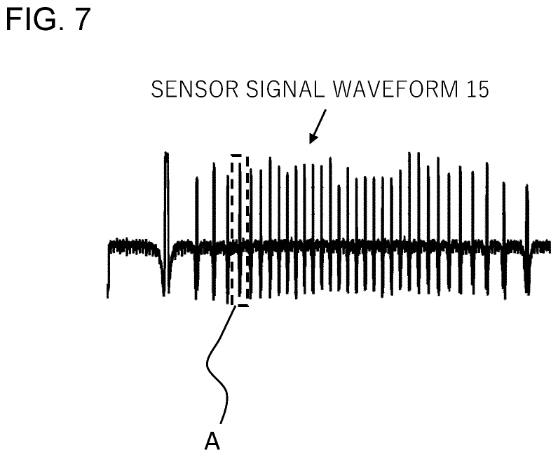

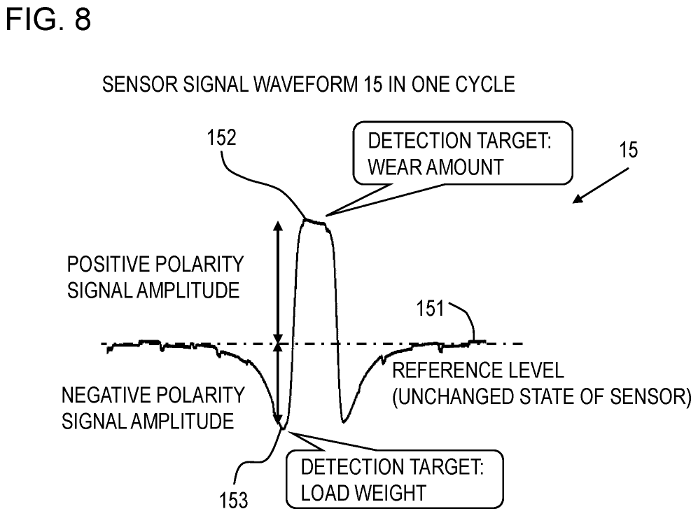

FIG. 7 is a waveform chart illustrating the sensor signal waveform 15 of the strain sensor 3, the sensor signal waveform 15 corresponding to the rotational state of the tire 101 according to the first embodiment. As illustrated in FIG. 7, since the tire 101 is rotating, the sensor signal waveform 15 of the strain sensor 3 sequentially repeats the reference level 151, the negative level negatively changing from the reference level 151, the positive level positively changing from the reference level 151, and the negative level negatively changing from the reference level 151. A signal value of the sensor signal waveform 15 can be represented by a signal amplitude. Also in FIGS. 6 to 7, the sensor signal waveform 15 is represented by amplitude. It suffices for the signal amplitude referred to here to be a value that represents the fluctuation width of the sensor signal waveform 15. The sensor signal waveform 15 has such a waveform that falling edge waveforms continue before and after a rising edge waveform, as in FIG. 8. For example, the amplitude of a second falling edge waveform can be treated as the amplitude of the sensor signal waveform 15. This is assumed in the following.

FIG. 8 is an explanatory diagram illustrating the sensor signal waveform 15 of the strain sensor 3 in one cycle according to the first embodiment. FIG. 8 is an enlarged view of an A part in FIG. 7. As illustrated in FIG. 8, the wear amount as the first physical quantity is detected at the peak value 152 of the positive level. The load weight as the second physical quantity is detected at the peak value 153 of the negative level.

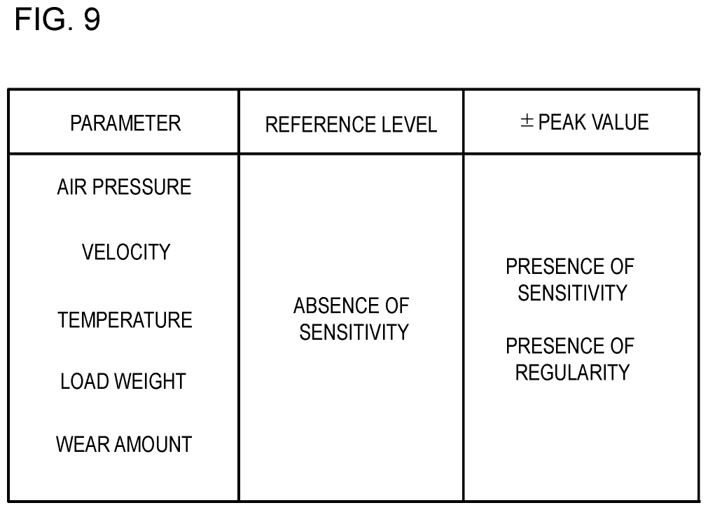

FIG. 9 is an explanatory diagram illustrating sensitivity to other parameters mixed in the sensor signal waveform 15 of the strain sensor 3 in one cycle according to the first embodiment. The sensor signal waveform 15 illustrated in FIG. 8 has an advantage in detecting the wear amount and the load weight. However, as illustrated in FIG. 9, an examination of the sensor signal waveform 15 output with traveling conditions changed indicates that the peak value 152 of the positive level and the peak value 153 of the negative level have sensitivity to the air pressure, the temperature, the velocity, the wear amount, and the load weight. That is, signals of the air pressure, the temperature, the velocity, the wear amount, and the load weight are mixed in the peak value 152 of the positive level and the peak value 153 of the negative level.

Incidentally, the reference level 151 does not have sensitivity to the air pressure, the temperature, the velocity, the wear amount, and the load weight. That is, signals of the air pressure, the temperature, the velocity, the wear amount, and the load weight are not mixed in the reference level 151.

### Changes in Output of Strain Sensor 3 in Initial State or Worn State of Tire 101

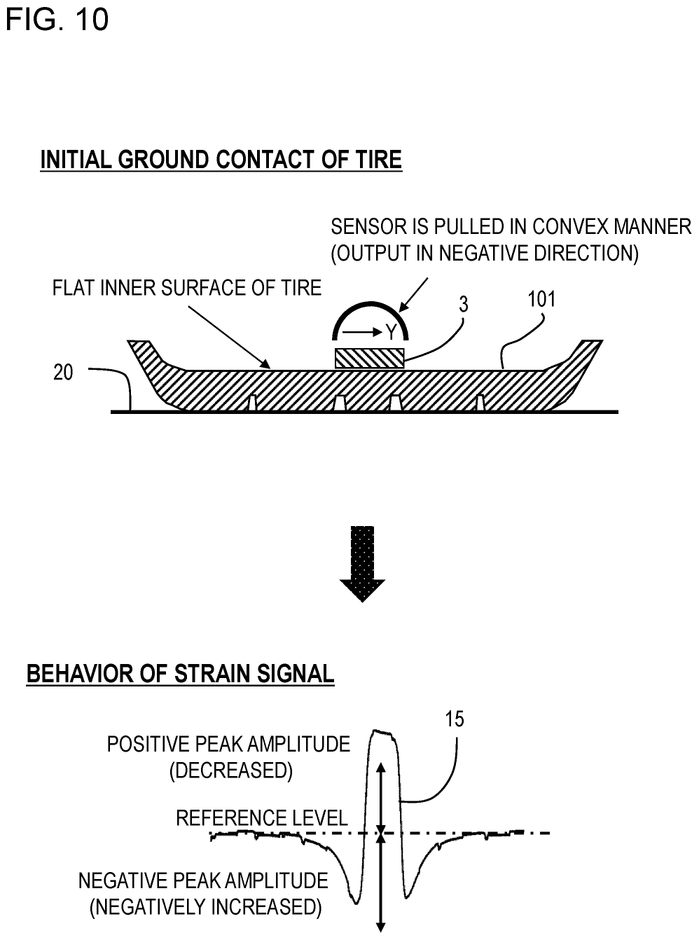

FIG. 10 is an explanatory diagram illustrating changes in the output of the strain sensor 3 in an initial state of the tire 101 according to the first embodiment. As illustrated in FIG. 10, the strain sensor 3 is pulled upward into a convex shape so as to conform to a flat surface of the inner circumference of the tire 101 according to the tire 101 in the initial state that is in ground contact with the road surface 20. The output of the strain sensor 3 is consequently increased in a negative direction.

Affected by the output of the strain sensor 3 increased in the negative direction, the peak value 152 of the positive level of the sensor signal waveform 15 is decreased. In addition, the peak value 153 of the negative level is increased.

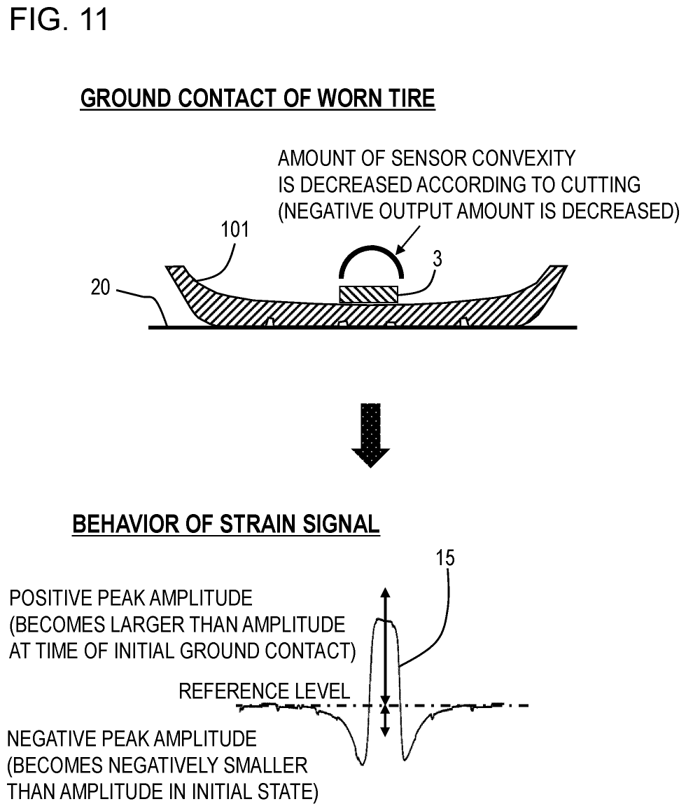

FIG. 11 is an explanatory diagram illustrating changes in the output of the strain sensor 3 in a worn state of the tire 101 according to the first embodiment. As illustrated in FIG. 11, the strain sensor 3 is pulled upward into a convex shape to a smaller degree than in the tire 101 in the initial state so as to conform to a downwardly concave surface of the inner circumference of the tire 101 according to the tire 101 in the worn state that is in ground contact with the road surface 20. The output of the strain sensor 3 is consequently decreased in the negative direction.

Affected by the output of the strain sensor 3 decreased in the negative direction, the peak value 152 of the positive level of the sensor signal waveform 15 is increased. In addition, the peak value 153 of the negative level is decreased.

### Changes in Output of Strain Sensor 3 at Air Pressures

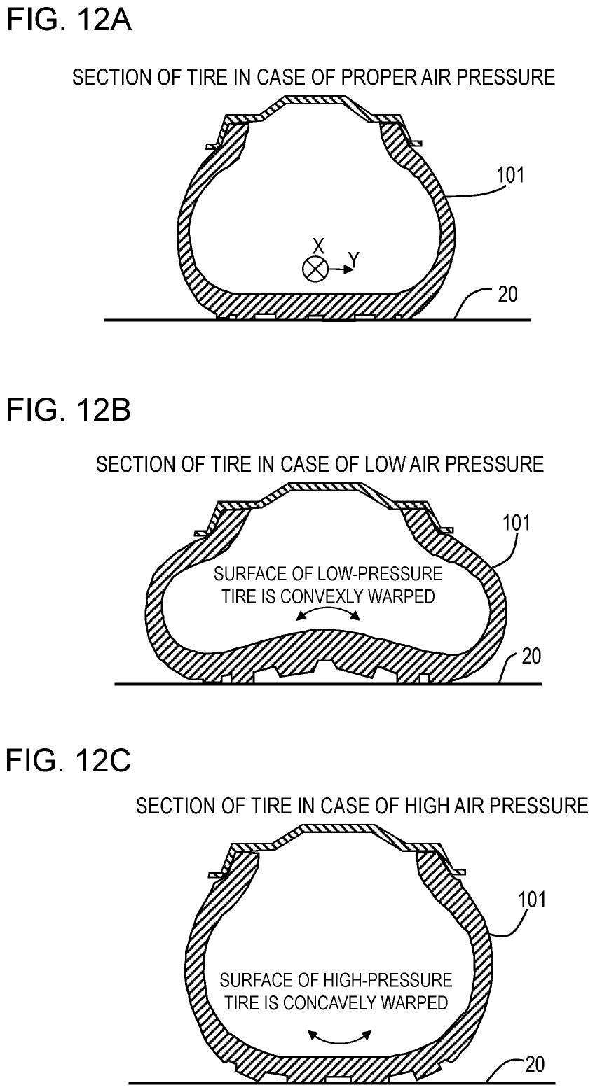

FIGS. 12A to 12C are explanatory diagrams illustrating changes in the output of the strain sensor 3 at air pressures of the tire 101 according to the first embodiment. FIG. 12A is a section of the tire 101 in a case of a proper air pressure. FIG. 12B is a section of the tire 101 in a case of a low air pressure. FIG. 12C is a section of the tire 101 in a case of a high air pressure.

FIG. 12A illustrates a section of the tire 101 in the case of a proper air pressure. As illustrated in FIG. 12A, the tire 101 in the case of a proper air pressure has a small effect of being pulled in an upward-downward direction on the output of the strain sensor 3. Consequently, the output of the strain sensor 3 does not easily shift in a positive direction or a negative direction.

The sensor signal waveform 15 is not affected by the output of the strain sensor 3 that does not easily shift in the positive direction or the negative direction, so that neither of the peak value 152 of the positive level and the peak value 153 of the negative level is increased or decreased.

FIG. 12B illustrates a section of the tire 101 in the case of a low air pressure. As illustrated in FIG. 12B, in the tire 101 in the case of a low air pressure, the output of the strain sensor 3 is pulled upward into a convex shape along an upwardly convex surface of the inner circumference of the tire 101. The output of the strain sensor 3 is consequently increased in the negative direction.

Affected by the output of the strain sensor 3 increased in the negative direction, the peak value 152 of the positive level of the sensor signal waveform 15 is decreased. In addition, the peak value 153 of the negative level is increased.

Incidentally, the phenomenon of the tire 101 in the case of a low air pressure occurs also in a case where the temperature of the tire 101 is a low temperature, in a case where the velocity of the tire 101 is a low velocity, and in a case where the load is small.

FIG. 12C illustrates a section of the tire 101 in the case of a high air pressure. As illustrated in FIG. 12C, in the tire 101 in the case of a high air pressure, the output of the strain sensor 3 is pulled downward into a concave shape along a downwardly concave surface of the inner circumference of the tire 101. The output of the strain sensor 3 is consequently increased in the positive direction.

Affected by the output of the strain sensor 3 increased in the positive direction, the peak value 152 of the positive level of the sensor signal waveform 15 is increased. In addition, the peak value 153 of the negative level is decreased.

Incidentally, the phenomenon of the tire 101 in the case of a high air pressure occurs also in a case where the temperature of the tire 101 is a high temperature, in a case where the velocity of the tire 101 is a high velocity, and in a case where the load weight is large.

As illustrated in FIGS. 12A to 12C, it is understood that, in extracting the wear amount and the load weight from the sensor signal waveform 15, it is necessary to correct the mixed-in air pressure, the temperature and the velocity causing other similar phenomena, and the other components of the wear amount and the load weight. However, in the present embodiment, the air pressure, the temperature, the velocity, and the load weight or the wear amount are not varied, but the physical quantity detecting device 10 detects the wear amount and the load weight with the air pressure, the temperature, the velocity, and the load weight or the wear amount restricted to predetermined traveling conditions.

That is, the physical quantity detecting device 10 makes the strain sensor 3 output the sensor signal waveform 15 under conditions under which at least the air pressure, the velocity, and the temperature as parameters of mixed-in signals mixed in the sensor signal waveform 15 are restricted to predetermined ranges as conditions of predetermined parameters corresponding to the first table 5 and the second table 6.

### Method of Generating First Table 5

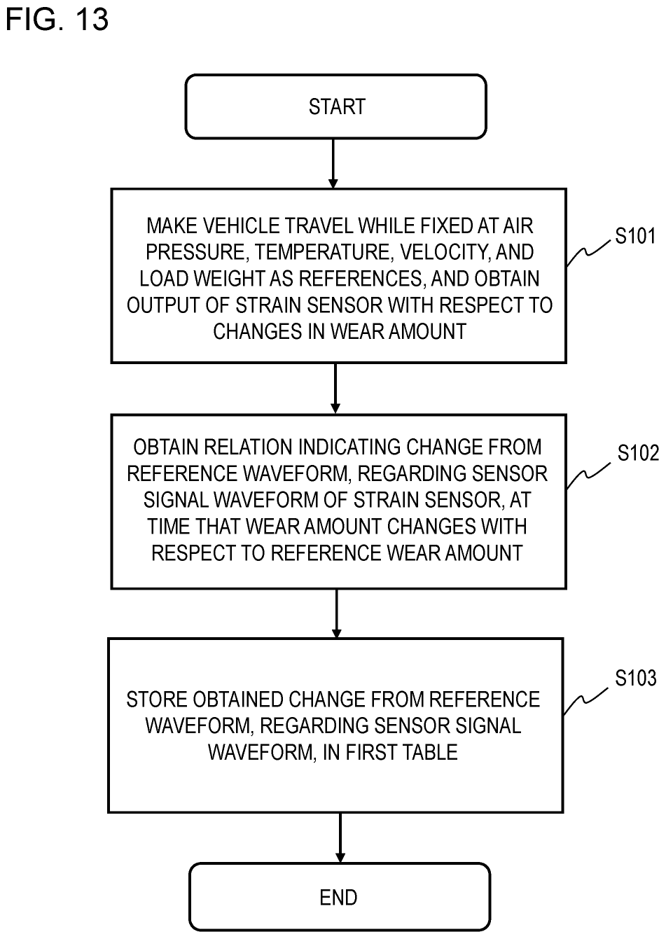

FIG. 13 is a flowchart for deriving the first table 5 of parameters mixed in the sensor signal waveform 15 of the strain sensor 3 according to the first embodiment.

As illustrated in FIG. 13, in S101, a predetermined control unit for a table generation test makes the vehicle 100 travel while maintained at an air pressure, a temperature, a velocity, and a load weight as references, and obtains the output of the strain sensor 3 with respect to changes in the wear amount.

In S102, the control unit obtains a relation indicating a change from a reference waveform, regarding the sensor signal waveform 15 of the strain sensor 3, at a time that the wear amount changes with respect to a reference wear amount when the vehicle 100 is made to travel while maintained at the air pressure, the temperature, the velocity, and the load weight as references.

In S103, the control unit stores, in the first table 5, the change from the reference waveform, regarding the sensor signal waveform 15, the change being obtained in S102.

The change in the sensor signal waveform 15 at the time that the wear amount changes may not necessarily need to be represented by using a difference from the reference wear amount and a difference from a reference signal value. However, the absolute value of the signal value differs for each vehicle type and each tire type. Thus, data similar to that of the first table 5 needs to be generated in advance for each of the absolute values. An amount of data is consequently increased greatly. Accordingly, the data amount is reduced by describing data by using the difference from the reference value.

In addition, the second table 6 can be derived when the vehicle 100 is made to travel while the traveling conditions of the vehicle 100 are fixed to the air pressure, the temperature, the velocity, and the wear amount as references in the above-described flowchart.

### First Table 5

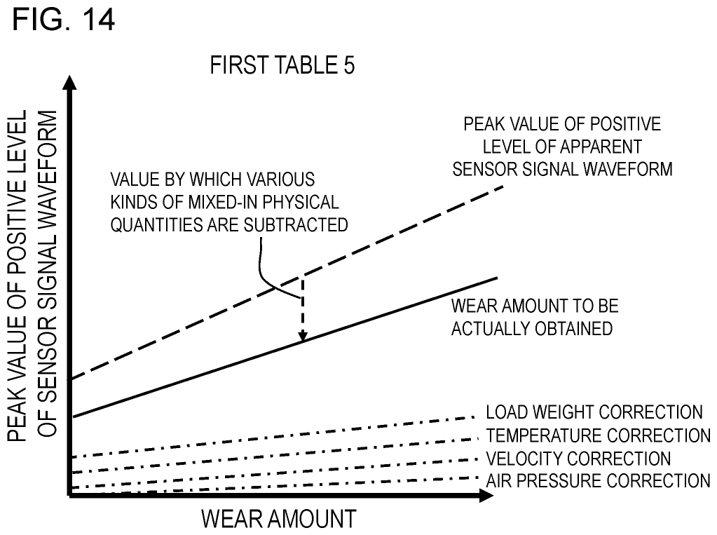

FIG. 14 is an explanatory diagram illustrating the first table 5 of the parameters mixed in the sensor signal waveform 15 of the strain sensor 3 according to the first embodiment. As illustrated in FIG. 14, the first table 5 is a proportional graph of such a correlation that, for the sensor signal waveform 15, a positively small correction amount is provided when the wear amount is small, and a positively large correction amount is provided when the wear amount is large. The first table 5 is stored in the storage section 411. In the first table 5, a line of the wear amount to be actually obtained is derived by subtracting values to be subtracted as correction amounts of various kinds of mixed-in physical quantities on lines of an air pressure correction, a velocity correction, a temperature correction, and a load weight correction from a line of the peak value 152 of the positive level of the apparent sensor signal waveform 15.

Here, changes in the sensor signal waveform 15 with respect to changes in the wear amount are illustrated. The estimating unit 4 obtains a relation between the wear amount acting on the tire 101 and the sensor signal waveform 15 at that time under the air pressure, the velocity, the temperature, and the load weight as references. For example, a relation as in FIG. 14 is obtained for each combination of a vehicle type of the vehicle 100 and a tire type. These relations may be obtained by actual measurements, or may be obtained by other means such as an appropriate simulation. In this case, a reference wear was set at 7.2 mm (corresponding to a groove depth of a new tire), a reference load was set at 340 kg (corresponding to two occupants), a reference air pressure was set at 220 kPa, and a reference temperature was set at 30° C. A reference velocity can, for example, be set at 7 km/h or the like. Similar relations may be obtained for velocities other than the reference speed.

### Second Table 6

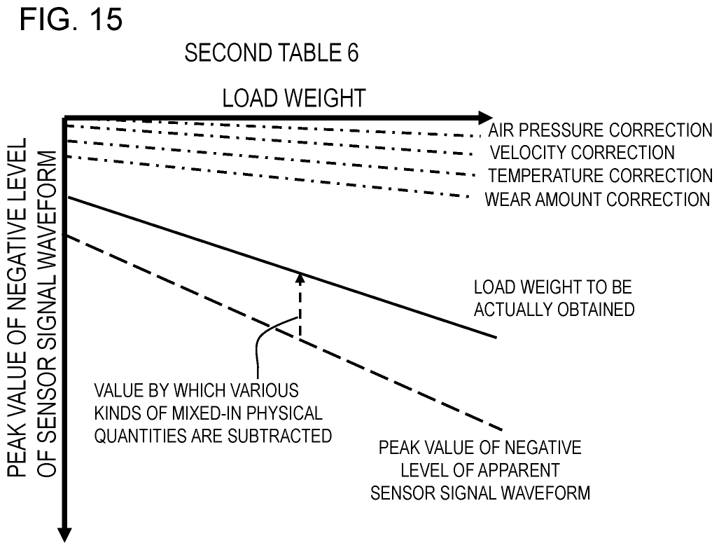

FIG. 15 is an explanatory diagram illustrating the second table 6 of parameters mixed in the sensor signal waveform 15 of the strain sensor 3 according to the first embodiment. As illustrated in FIG. 15, the second table 6 is a proportional graph of such a correlation that, for the sensor signal waveform 15, a negatively small correction amount is provided when the load weight is small, and a negatively large correction amount is provided when the load weight is large. The second table 6 is stored in the storage section 421. In the second table 6, a line of the wear amount to be actually obtained is derived by subtracting values to be subtracted as correction amounts of various kinds of mixed-in physical quantities on lines of an air pressure correction, a velocity correction, a temperature correction, and a wear amount correction from a line of the peak value 153 of the negative level of the apparent sensor signal waveform 15.

Traveling conditions under the air pressure, the velocity, the temperature, and the wear amount as references similar to those of the first table 6 are set also for the second table 6.

### Physical Quantity Detecting Method

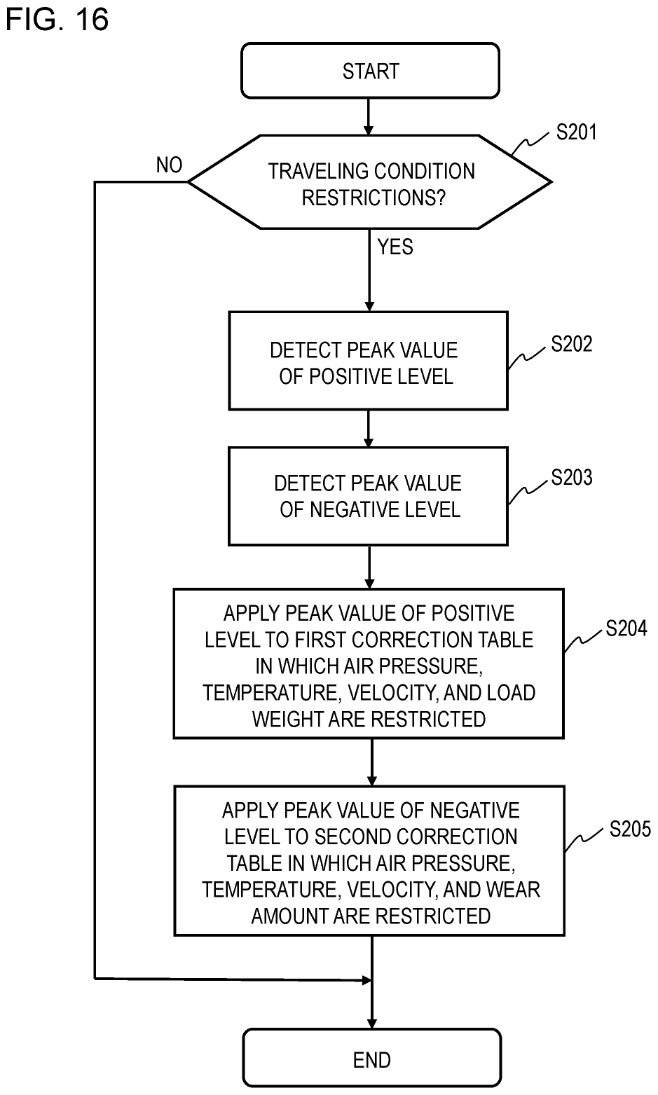

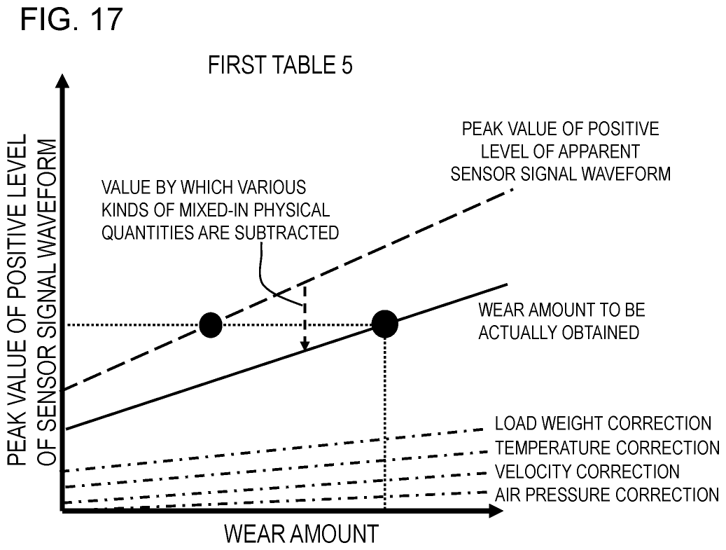

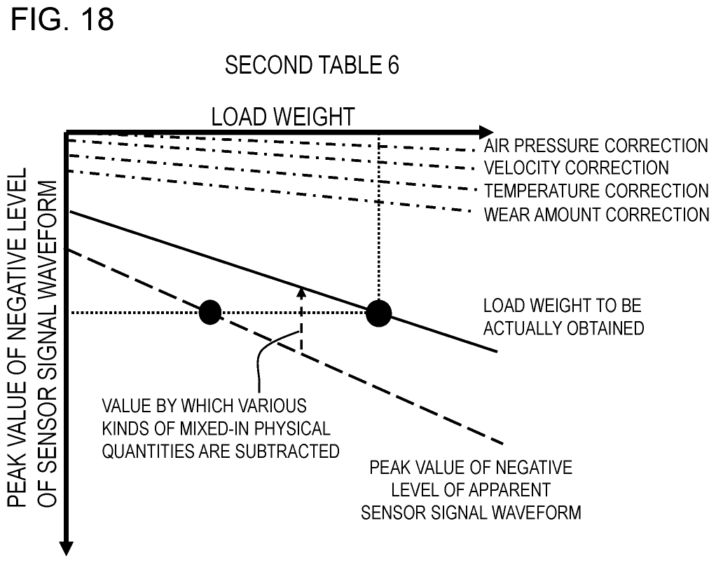

FIG. 16 is a flowchart for estimating the wear amount and the load weight of the tire 101 from the sensor signal waveform 15 of the strain sensor 3 according to the first embodiment. FIG. 17 is a diagram of assistance in explaining estimating the wear amount of the tire 101 by applying the sensor signal waveform 15 of the strain sensor 3 according to the first embodiment to the first table 5. FIG. 18 is a diagram of assistance in explaining estimating the load weight of the tire 101 by applying the sensor signal waveform 15 of the strain sensor 3 according to the first embodiment to the second table 6.

The flowchart of the physical quantity detecting method illustrated in FIG. 16 is repeatedly performed during the traveling of the vehicle 100.

When the physical quantity detecting method is performed, in S201, the estimating unit 4 determines whether or not traveling condition restrictions in the traveling condition restricting sections 412 and 422 hold in a traveling state of the vehicle 100. The traveling condition restrictions refer to conditions matching traveling conditions at the times of deriving the first table 5 and the second table 6. When the traveling condition restrictions in the traveling condition restricting sections 412 and 422 hold in S201, the processing proceeds to S202. When the traveling condition restrictions in the traveling condition restricting sections 412 and 422 do not hold in S201, the processing of the physical quantity detecting method is temporarily ended.

In S202, the estimating unit 4 detects the peak value 152 of the positive level of the sensor signal waveform 15 output by the strain sensor 3. After the processing of S202, the processing proceeds to S203.

In S203, the estimating unit 4 detects the peak value 153 of the negative level of the sensor signal waveform 15 output by the strain sensor 3. After the processing of S203, the processing proceeds to S204.

In S204, as illustrated in FIG. 17, the estimating unit 4 applies the peak value 152 of the positive level of the sensor signal waveform 15 output by the strain sensor 3, the peak value 152 being detected in S202, to the first table 5 stored by the storage section 411. The estimating unit 4 thereby estimates the wear amount as the first physical quantity. The estimated wear amount is transmitted to the reporting unit 103. After the processing of S204, the processing proceeds to S205.

In S205, as illustrated in FIG. 18, the estimating unit 4 applies the peak value 153 of the negative level of the sensor signal waveform 15 output by the strain sensor 3, the peak value 153 being detected in S203, to the second table 6 stored by the storage section 421. The estimating unit 4 thereby estimates the load weight as the second physical quantity. The estimated load weight is transmitted to the reporting unit 103. After the processing of S205, the processing of the physical quantity detecting method is temporarily ended.

### Wear Amount Estimation Result

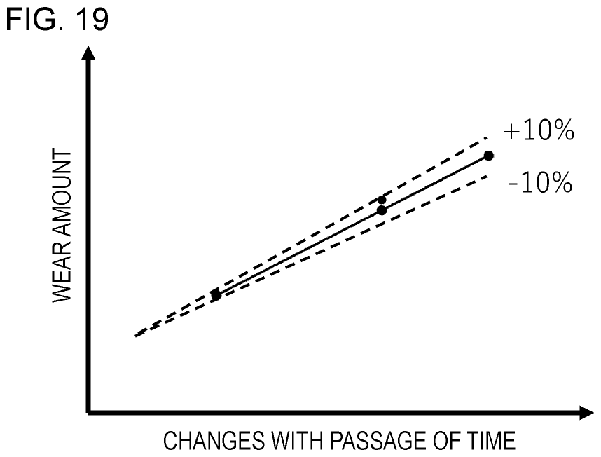

FIG. 19 is an explanatory diagram illustrating a wear amount estimation result according to the first embodiment. As illustrated in FIG. 19, it was confirmed that a result of performing computation with actual vehicle data under conditions of an air pressure of 220 kPa, a velocity of 2.4 m/s (approximately 9 km/h), 30° C., and the riding of two people indicated a substantially excellent accuracy of 5.4 mm for a tire groove depth of 5 mm, and that a wear estimation error was 10% or less.

### Load Weight Estimation Result

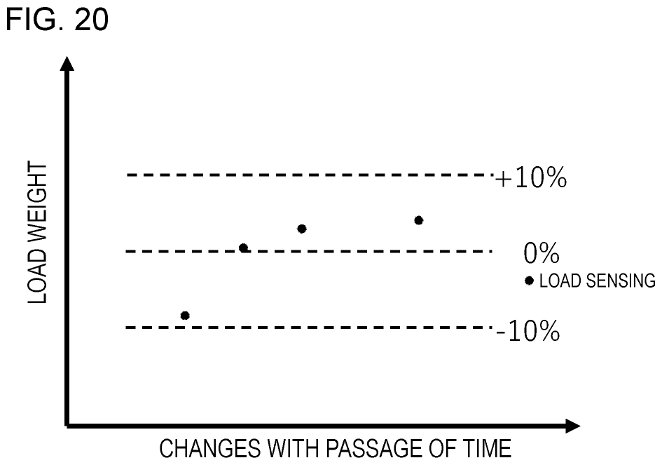

FIG. 20 is an explanatory diagram illustrating a load weight estimation result according to the first embodiment. As illustrated in FIG. 20, it was confirmed that a result of performing computation with actual vehicle data under conditions of a velocity of 2.4 m/s (approximately 9 km/h), 30° C., the riding of two people, and a tire groove depth of 5 mm indicated a substantially excellent accuracy tendency on a low air pressure side for an actually measured load of 340 kg, that is, indicated 313 kg, and that a load estimation error was 10% or less.

### Second Embodiment

In the following, an embodiment obtained by modifying the foregoing embodiment is described. In the following, the description of items similar to those of the first embodiment is omitted with the same reference numerals provided to the same configurations, and characteristic parts thereof are described.

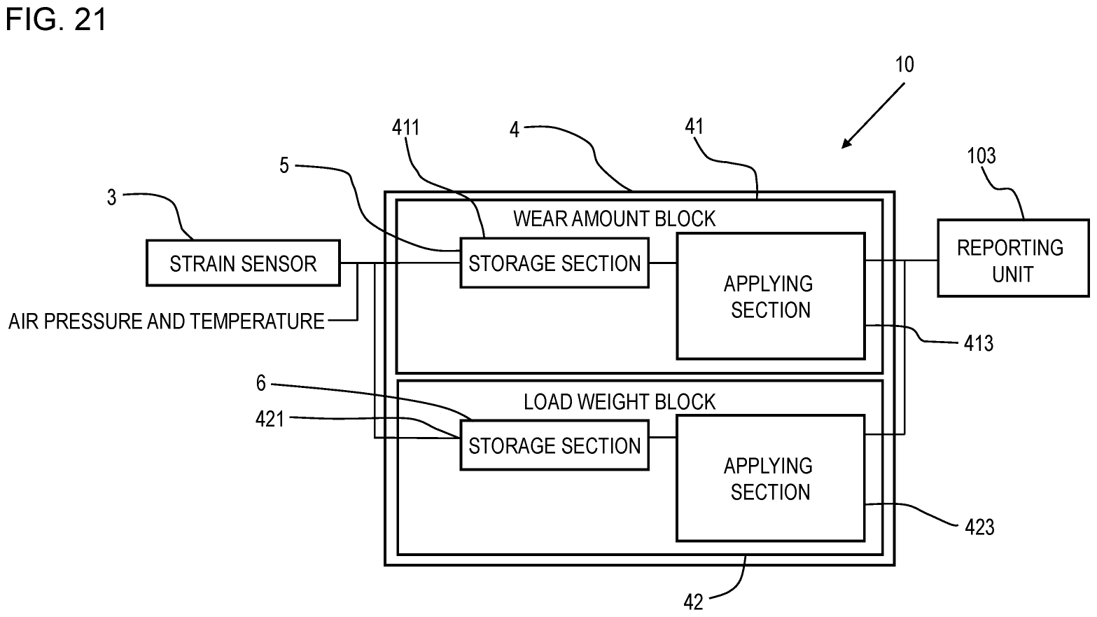

FIG. 21 is a configuration diagram illustrating a physical quantity detecting device 10 according to a second embodiment. As illustrated in FIG. 21, in the second embodiment, the estimating unit 4 does not have the traveling condition restricting sections, but estimates the wear amount and the load weight even when the air pressure, the temperature, the velocity, the load weight, and the wear amount are variable values.

### First Table 5

Correlations between the peak value 152 of the positive level of the sensor signal waveform 15 of the strain sensor 3 and the air pressure, the temperature, the velocity, and the load weight are stored in advance with these values varied.

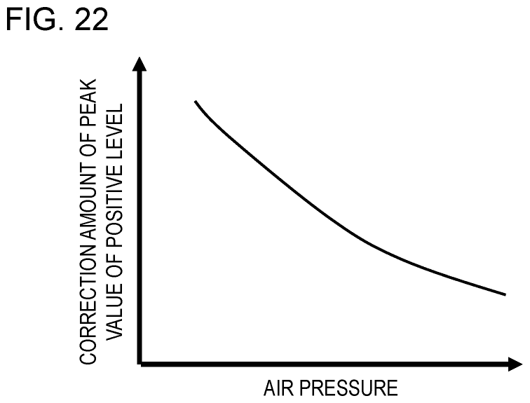

FIG. 22 is an explanatory diagram illustrating an air pressure correlation table of the first table, the air pressure correlation table illustrating a correlation between a correction amount of the peak value of the positive level of the sensor signal waveform 15 of the strain sensor 3 according to the second embodiment and the air pressure. The table illustrated in FIG. 22 provides such a correlation that, when the air pressure is increased, the correction amount of the peak value 152 of the positive level of the sensor signal waveform 15 is decreased.

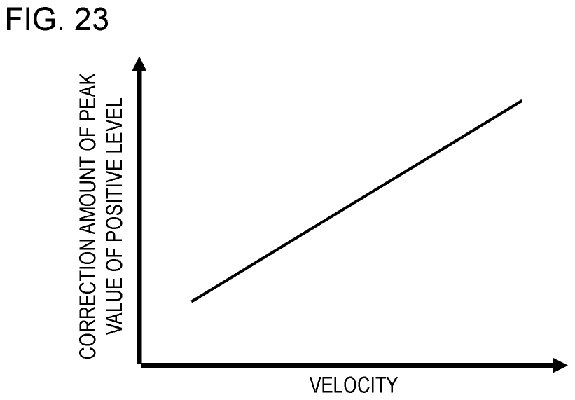

FIG. 23 is an explanatory diagram illustrating a temperature correlation table of the first table 5, the temperature correlation table illustrating a correlation between a correction amount of the peak value 152 of the positive level of the sensor signal waveform 15 of the strain sensor 3 according to the second embodiment and the velocity. The table illustrated in FIG. 23 provides such a correlation that, when the velocity is increased, the correction amount of the peak value 152 of the positive level of the sensor signal waveform 15 is increased.

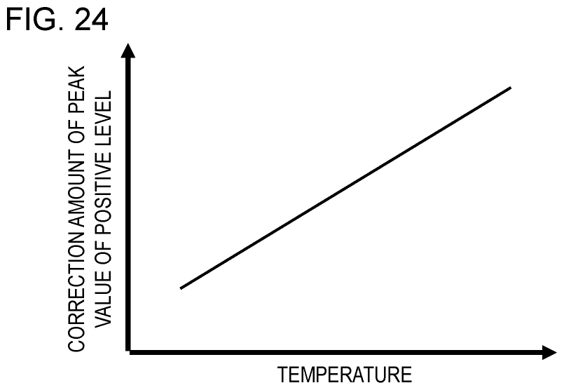

FIG. 24 is an explanatory diagram illustrating a temperature correlation table of the first table 5, the temperature correlation table illustrating a correlation between a correction amount of the peak value 152 of the positive level of the sensor signal waveform 15 of the strain sensor 3 according to the second embodiment and the temperature. The table illustrated in FIG. 24 provides such a correlation that, when the temperature is increased, the correction amount of the peak value 152 of the positive level of the sensor signal waveform 15 is increased.

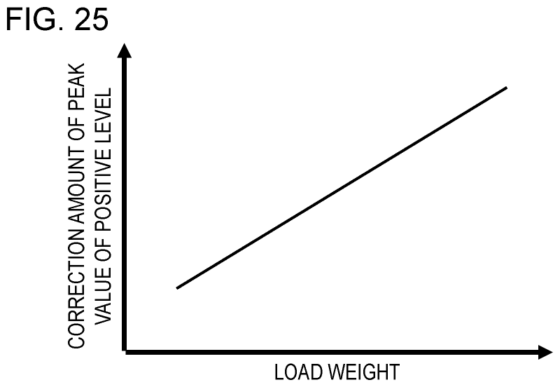

FIG. 25 is an explanatory diagram illustrating a load weight correlation table of the first table 5, the load weight correlation table illustrating a correlation between a correction amount of the peak value 152 of the positive level of the sensor signal waveform 15 of the strain sensor 3 according to the second embodiment and the load weight. The table illustrated in FIG. 25 provides such a correlation that, when the load weight is increased, the correction amount of the peak value 152 of the positive level of the sensor signal waveform 15 is increased.

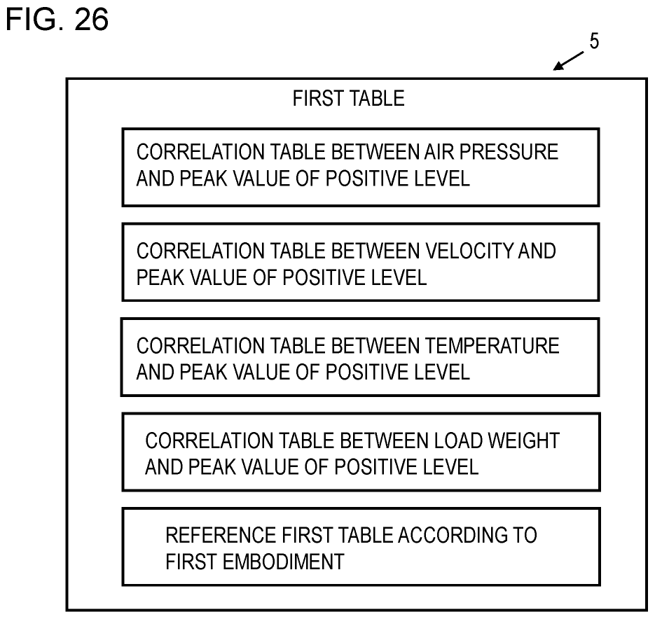

FIG. 26 is an explanatory diagram illustrating the first table 5 including various kinds of tables according to the second embodiment. As illustrated in FIG. 26, the first table 5 includes the reference first table of the first embodiment and the tables of the various kinds of correlations in FIGS. 21 to 25. Therefore, the wear amount as the first physical quantity can be estimated by applying the peak value 152 of the positive level of the sensor signal waveform 15 output by the strain sensor 3 in the vehicle 100 traveling variously to the first table 5 stored by the storage section 411.

Specifically, the correction amounts of the peak value 152 of the positive level of the sensor signal waveform 15 are derived by respectively applying the air pressure, the velocity, the temperature, and the load weight to the tables of the various kinds of correlations. Then, the peak value 152 of the positive level of the sensor signal waveform 15 is applied to the reference first table. At this time, in the reference first table, the derived correction amounts are applied to the correction amounts in the reference first table. The wear amount as the first physical quantity is thereby estimated.

### Second Table 6

Correlations between the peak value 153 of the negative level of the sensor signal waveform 15 of the strain sensor 3 and the air pressure, the temperature, the velocity, and the wear amount are stored in advance with these values varied.

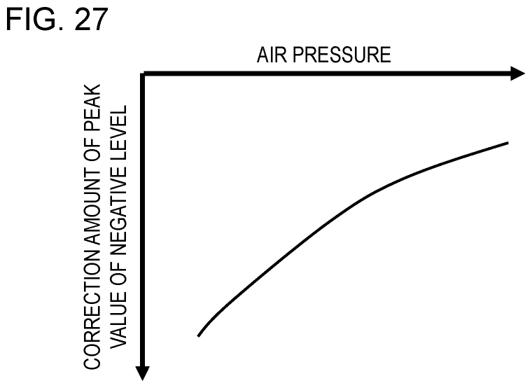

FIG. 27 is an explanatory diagram illustrating an air pressure correlation table of the second table 6, the air pressure correlation table illustrating a correlation between a correction amount of the peak value 153 of the negative level of the sensor signal waveform 15 of the strain sensor 3 according to the second embodiment and the air pressure. The table illustrated in FIG. 27 provides such a correlation that, when the air pressure is increased, the correction amount of the peak value 153 of the negative level of the sensor signal waveform 15 is decreased.

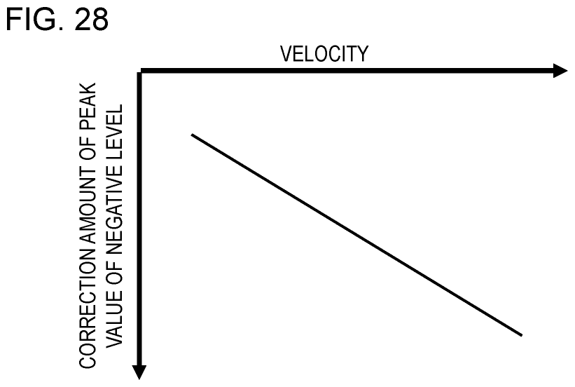

FIG. 28 is an explanatory diagram illustrating a velocity correlation table of the second table 6, the velocity correlation table illustrating a correlation between a correction amount of the peak value 153 of the negative level of the sensor signal waveform 15 of the strain sensor 3 according to the second embodiment and the velocity. The table illustrated in FIG. 28 provides such a correlation that, when the velocity is increased, the correction amount of the peak value 153 of the negative level of the sensor signal waveform 15 is increased.

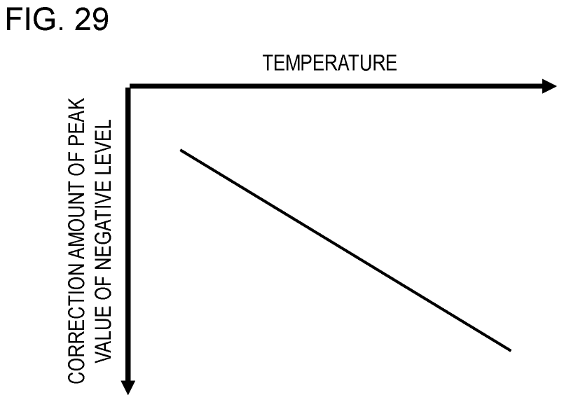

FIG. 29 is an explanatory diagram illustrating a temperature correlation table of the second table 6, the temperature correlation table illustrating a correlation between a correction amount of the peak value 153 of the negative level of the sensor signal waveform 15 of the strain sensor 3 according to the second embodiment and the temperature. The table illustrated in FIG. 29 provides such a correlation that, when the temperature is increased, the correction amount of the peak value 153 of the negative level of the sensor signal waveform 15 is increased.

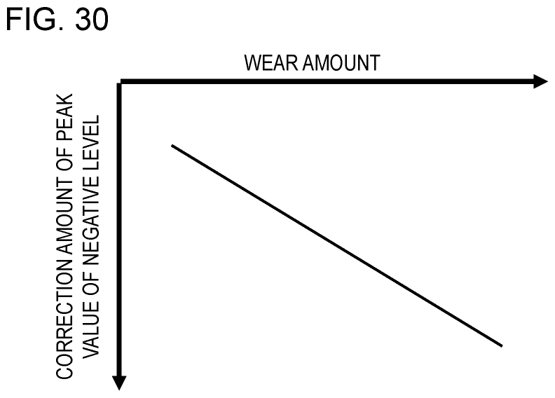

FIG. 30 is an explanatory diagram illustrating a wear amount correlation table of the second table 6, the wear amount correlation table illustrating a correlation between a correction amount of the peak value 153 of the negative level of the sensor signal waveform 15 of the strain sensor 3 according to the second embodiment and the wear amount. The table illustrated in FIG. 30 provides such a correlation that, when the wear amount is increased, the correction amount of the peak value 153 of the negative level of the sensor signal waveform 15 is increased.

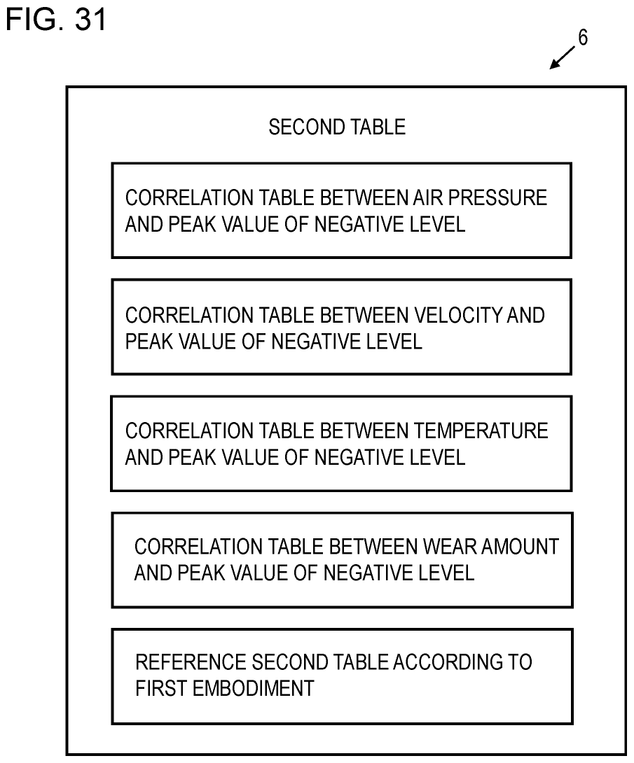

FIG. 31 is an explanatory diagram illustrating the second table 6 including the various kinds of tables according to the second embodiment and the reference second table of the first embodiment. As illustrated in FIG. 31, the second table 6 includes the reference second table and the tables of the various kinds of correlations in FIGS. 27 to 30. Therefore, the load weight as the second physical quantity can be estimated by applying the peak value 153 of the negative level of the sensor signal waveform 15 output by the strain sensor 3 in the vehicle 100 traveling variously to the second table 6 stored by the storage section 421.

Specifically, the correction amounts of the peak value 153 of the negative level of the sensor signal waveform 15 are derived by respectively applying the air pressure, the velocity, the temperature, and the wear amount to the tables of the various kinds of correlations. Then, the peak value 153 of the negative level of the sensor signal waveform 15 is applied to the reference second table. At this time, in the reference second table, the derived correction amounts are applied to the correction amounts in the reference second table. The load weight as the second physical quantity is thereby estimated.

### Physical Quantity Detecting Method

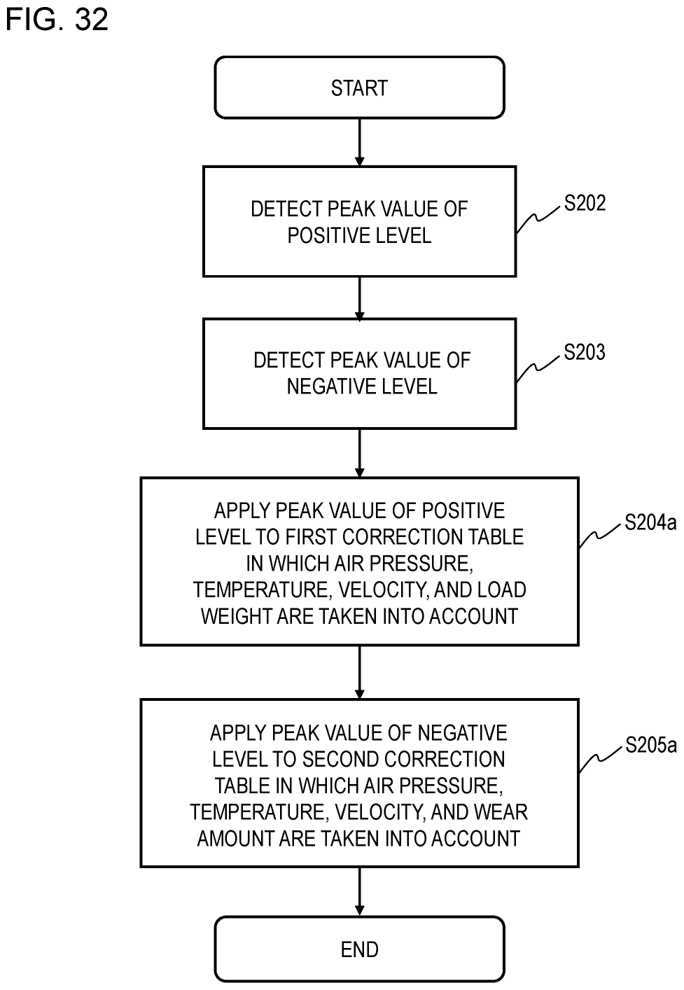

FIG. 32 is a flowchart for estimating the wear amount and the load weight of the tire 101 from the sensor signal waveform 15 of the strain sensor 3 according to the second embodiment.

The flowchart of the physical quantity detecting method illustrated in FIG. 32 is repeatedly performed during the traveling of the vehicle 100. The processing of S201 in the first embodiment is absent in the second embodiment.

When the physical quantity detecting method is performed, in S202, the estimating unit 4 detects the peak value 152 of the positive level of the sensor signal waveform 15 output by the strain sensor 3. After the processing of S202, the processing proceeds to S203.

In S203, the estimating unit 4 detects the peak value 153 of the negative level of the sensor signal waveform 15 output by the strain sensor 3. After the processing of S203, the processing proceeds to S204a.

In S204a, the estimating unit 4 applies the peak value 152 of the positive level of the sensor signal waveform 15 output by the strain sensor 3, the peak value 152 being detected in S202, to the first table 5 stored by the storage section 411. The estimating unit 4 thereby estimates the wear amount as the first physical quantity. The estimated wear amount is transmitted to the reporting unit 103. After the processing of S204, the processing proceeds to S205a.

Here, the first table 5 stores the various kinds of tables of the air pressure, the velocity, the temperature, and the load weight that vary. Therefore, the wear amount can be estimated without the traveling conditions being restricted.

In S205a, the estimating unit 4 applies the peak value 153 of the negative level of the sensor signal waveform 15 output by the strain sensor 3, the peak value 153 being detected in S203, to the second table 6 stored by the storage section 421. The estimating unit 4 thereby estimates the load weight as the second physical quantity. The estimated load weight is transmitted to the reporting unit 203. After the processing of S205a, the processing of the physical quantity detecting method is temporarily ended.

Here, the second table 6 stores the various kinds of tables of the air pressure, the velocity, the temperature, and the wear amount that vary. Therefore, the load weight can be estimated without the traveling conditions being restricted.

### Third Embodiment

A third embodiment includes a reporting unit 103 that distinguishes a range of the wear amount as the first physical quantity or the load weight as the second physical quantity in a plurality of stages, and warns of a state in each stage. Here, the reporting unit 103 gives a warning of the wear amount.

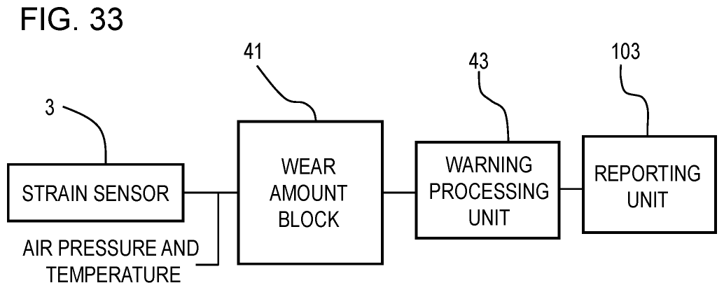

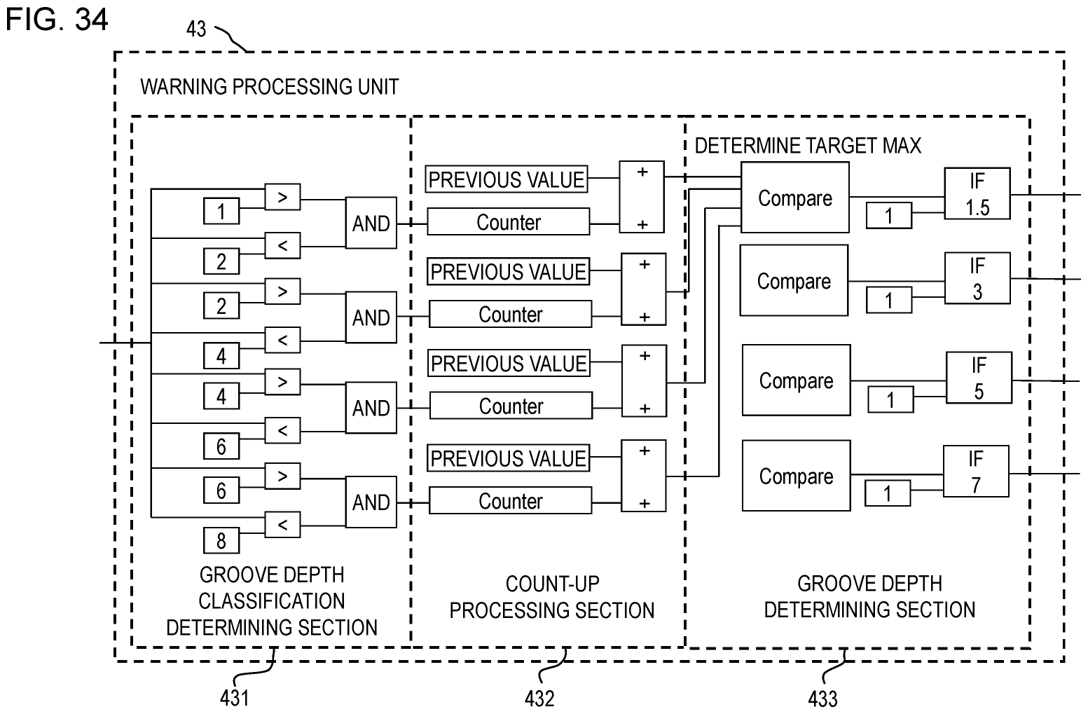

FIG. 33 is a configuration diagram illustrating a wear amount estimating part of a physical quantity detecting device 10 according to the third embodiment. FIG. 34 is a detailed configuration diagram illustrating a warning processing unit 43 according to the third embodiment.

As illustrated in FIG. 33 and FIG. 34, the physical quantity detecting device 10 has a configuration obtained by further adding the warning processing unit 43 that warns of the wear amount. The warning processing unit 43 includes a groove depth classification determining section 431, a count-up processing section 432, and a groove depth determining section 433. The groove depth classification determining section 431 sorts groove depths into four groups. The count-up processing section 432 counts the numbers of pieces of data of the respective groove depths for obtaining a distribution of the groove depths. The groove depth determining section 433 determines a groove depth whose number of pieces of data is largest in an aggregate of the numbers of pieces of data of the respective groove depths, and outputs 1, 3, 5, or 7 mm to the reporting unit 103 according to the groove depth at that time. The warning processing unit 43 thereby distinguishes the range of the wear amount in a plurality of stages, and warns the reporting unit 103 of a state in each stage.

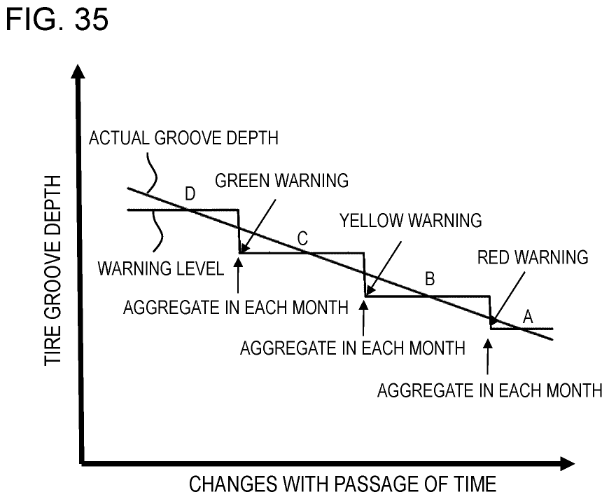

FIG. 35 is an explanatory diagram illustrating operation states of wear warnings according to the third embodiment. As illustrated in FIG. 35, in a state in which the tire 101 is new, wear has not progressed, and therefore there is considered to be a low necessity for detecting the wear amount, so that a system for notifying about the wear amount in real time is not necessary. Accordingly, in the third embodiment, the physical quantity detecting device 10 is configured to notify about wear amounts for which to display warnings when the groove depth is decreased. Specifically, groove depths are divided into four groups, for example, A “1 to 2 mm,” B “2 to 4 mm,” C “4 to 6 mm,” and D “6 mm or more.” Then, a method of counting for each group in one-month unit is set. For example, when the groove depth corresponds to C “4 to 6 mm,” the reporting unit 103 gives a green warning (alarm indicating that a tire replacement is not necessary). When the groove depth corresponds to B “2 to 4 mm,” the reporting unit 103 gives a yellow warning (alarm indicating that a tire replacement is imminent). When the groove depth corresponds to A “1 to 2 mm,” the reporting unit 103 gives a red warning (alarm indicating that a tire replacement is necessary).

In a case where the groove depth in each one-month aggregate is 1.6 mm, for example, the groove depth corresponds to the groove depth group A “1 to 2 mm” in the warning processing unit 43, and a groove depth output of “1 mm” is selected by the groove depth determining section 433. Then, the reporting unit 104 displays the red warning.

By thus including the warning processing unit 43 in the physical quantity detecting device 10, it is possible to detect the wear amount with high accuracy, and determine the groove depth correctly. Thus, a tire replacement timing can be recognized correctly on the basis of the warning display.

### Effects

(A) The physical quantity detecting device 10 detects a plurality of different physical quantities on the basis of an output signal waveform. The physical quantity detecting device 10 includes the strain sensor 3 as one sensor element that outputs the sensor signal waveform 15 having the reference level 151, the positive level positively changing from the reference level 151, and the negative level negatively changing from the reference level 151. The physical quantity detecting device 10 includes the estimating unit 4 that estimates the first physical quantity corresponding to the peak value 152 of the positive level and the second physical quantity corresponding to the peak value 153 of the negative level on the basis of the sensor signal waveform 15 output by the strain sensor 3.

With this configuration, at least two detection values are distinguished from one peak 152 and the other peak 153 of the positive level and the negative level with respect to the reference level 151 of the sensor signal waveform 15 output by the one strain sensor 3. A plurality of physical quantities are thereby detected together on the basis of the two detection values of the one strain sensor 3. Hence, the plurality of physical quantities are detected together with high accuracy from the sensor signal waveform 15 output by the one strain sensor 3 and including the plurality of physical quantities.

(B) The estimating unit 4 includes the storage section 411 that stores the first table 5 of the first physical quantity corresponding to the peak value 152 of the positive level of the sensor signal waveform 15. The estimating unit 4 includes the storage section 421 that stores the second table 6 of the second physical quantity corresponding to the peak value 153 of the negative level of the sensor signal waveform 15. The estimating unit 4 estimates the first physical quantity by applying the peak value 152 of the positive level of the sensor signal waveform 15 output by the strain sensor 3 to the first table 5 stored by the storage section 411. The estimating unit 4 estimates the second physical quantity by applying the peak value 153 of the negative level of the sensor signal waveform 15 output by the strain sensor 3 to the second table 6 stored by the storage section 421.

With this configuration, the first physical quantity and the second physical quantity intended to be detected are detected together with high accuracy by applying the sensor signal waveform 15 output by the one strain sensor 3 and including the plurality of physical quantities to each of the first table 5 and the second table 6 of the storage sections 411 and 421.

(C) The sensor element is the strain sensor 3.

With this configuration, the sensor element is the strain sensor 3. Thus, even when the sensor signal waveform 15 includes mixed-in components originating from physical quantities, an effect is not easily produced on a strain to be detected under conditions of the predetermined parameters. Hence, the accuracy of detection of strains of the plurality of physical quantities intended to be detected is improved.

(D) The estimating unit 4 makes a temperature correction to the peak value 152 of the positive level and the peak value 153 of the negative level of the sensor signal waveform 15 output by the strain sensor 3.

With this configuration, a temperature correction is made to both of the peak values 152 and 153 even when the sensor signal waveform 15 includes a mixed-in component originating from the temperature. This improves the accuracy of detection of the plurality of physical quantities intended to be detected.

(E) The estimating unit includes two independent blocks, that is, the wear amount block 41 and the load weight block 42 that respectively estimate the first physical quantity and the second physical quantity.

With this configuration, the two independent blocks, that is, the wear amount block 41 and the load weight block 42 respectively estimate the first physical quantity and the second physical quantity. This improves the velocity of computation and the accuracy of detection of the first physical quantity and the second physical quantity intended to be detected.

(F) The strain sensor 3 is disposed in the tire 101. The strain sensor 3 outputs the peak value 152 of the positive level of the sensor signal waveform 15 in a state in which the tire 101 is in ground contact with the road surface 20. The strain sensor 3 outputs the peak value 153 of the negative level of the sensor signal waveform 15 at a moment that the tire 101 comes into ground contact with or separates from the road surface 20.

With this configuration, the first physical quantity and the second physical quantity are detected together in time series with high accuracy from the sensor signal waveform 15 that is output by the one strain sensor 3 disposed in the tire 101 and includes the plurality of physical quantities.

(G) The first physical quantity is the wear amount. The second physical quantity is the load weight.

With this configuration, the wear amount and the load weight are detected together with high accuracy from the sensor signal waveform 15 that is output by the one strain sensor 3 and includes the plurality of physical quantities.

(H) The physical quantity detecting device 10 makes the strain sensor 3 output the sensor signal waveform 15 under conditions of predetermined parameters corresponding to the first table 5 and the second table 6.

With this configuration, it can be made sufficient to perform certain correction processing while restricting the conditions of parameters of the components mixed in the sensor signal waveform 15 output by the one strain sensor 3. Thus, the plurality of physical quantities are detected together with high accuracy on the basis of the sensor signal waveform 15.

(I) The physical quantity detecting device 10 makes the strain sensor 3 output the sensor signal waveform 15 under conditions under which at least the air pressure, the velocity, and the temperature as parameters of mixed-in signals mixed in the sensor signal waveform 15 are restricted to predetermined ranges as conditions of predetermined parameters corresponding to the first table 5 and the second table 6.

With this configuration, it can be made sufficient to perform certain correction processing while restricting the conditions of parameters of the air pressure, the velocity, and the load weight among the components mixed in the sensor signal waveform 15 output by the one strain sensor 3. Thus, the plurality of physical quantities are detected together with high accuracy on the basis of the sensor signal waveform 15.

(J) The strain sensor 3 is disposed in the tire 101. The estimating unit 4 obtains the temperature of the tire 101.

With this configuration, a temperature correction is made to both of the peak values 152 and 153 even when the sensor signal waveform 15 includes the mixed-in component originating from the temperature. This improves the accuracy of detection of the plurality of physical quantities intended to be detected.

(K) The strain sensor 3 is disposed in the tire 101. The estimating unit 4 obtains the velocity by dividing the outer circumference of the tire by the output cycle of the sensor signal waveform 15.

With this configuration, a velocity correction is made to both of the peak values 152 and 153 even when the sensor signal waveform 15 includes the mixed-in component originating from the velocity. This improves the accuracy of detection of the plurality of physical quantities intended to be detected.

(L) The strain sensor 3 is disposed in the tire 101. The estimating unit 4 obtains the air pressure of the tire 101.

With this configuration, an air pressure correction is made to both of the peak values 152 and 153 even when the sensor signal waveform 15 includes the mixed-in component originating from the air pressure. This improves the accuracy of detection of the plurality of physical quantities intended to be detected.

(M) The physical quantity detecting device 10 includes the warning processing unit 43 that distinguishes the range of the first physical quantity or the second physical quantity in a plurality of stages, and warns of a state in each stage.

With this configuration, the warning processing unit 43 warns a user of a state in each stage set by distinguishing the range of the first physical quantity or the second physical quantity in the plurality of stages. This enables the user to grasp the state of the first physical quantity or the second physical quantity in each stage on the reporting unit 103.

(N) The strain sensor 3 is disposed at a center in the tire width direction on the inner circumferential side of the tire 101.

With this configuration, the sensor signal waveform 15 output by the one strain sensor 3 is detected in a well-balanced manner in response to deformations on both sides of the strain sensor 3 in the tire width direction in the tire 101. This improves the accuracy of detection of the plurality of physical quantities intended to be detected.

(O) The one sensor element is the strain sensor 3 including the plurality of detecting units 31 to 34 arranged in a plurality of rows and a plurality of columns in the X-direction and the Y-direction orthogonal to each other. The strain sensor 3 is disposed in the tire 101 such that either the X-direction or the Y-direction in which at least two detecting units 31 to 34 are arranged side by side to produce output is set along the rotational direction of the tire.

With this configuration, the sensor element is the strain sensor 3. Thus, a strain of output of the positive level or the negative level in response to a deformation following the rotation of the tire 101 is detected. This improves the accuracy of detection of strains of the plurality of physical quantities intended to be detected.

Embodiments of the present invention have been described above. However, the foregoing embodiments merely represent a part of examples of application of the present invention, and are not intended to limit the technical scope of the present invention to concrete configurations of the foregoing embodiments.

### DESCRIPTION OF REFERENCE CHARACTERS

1: Air pressure sensor
2: Temperature sensor
3: Strain sensor
4: Estimating unit
5: First table
6: Second table
10: Physical quantity detecting device
15: Sensor signal waveform
20: Road surface
41: Wear amount block
42: Load weight block
43: Warning processing unit
100: Vehicle
101: Tire
102: ECU
103: Reporting unit
151: Reference level
152: Peak value of a positive level
153: Peak value of a negative level
411: Storage section
412: Traveling condition restricting section
413: Applying section
421: Storage section
422: Traveling condition restricting section
423: Applying section
431: Groove depth classification determining section
432: Count-up processing section
433: Groove depth determining section

1. A physical quantity detecting device for detecting a plurality of different physical quantities on a basis of an output signal waveform, the physical quantity detecting device comprising:
one sensor element that outputs a sensor signal waveform having a reference level, a positive level positively changing from the reference level, and a negative level negatively changing from the reference level; and
an estimating unit that estimates a first physical quantity corresponding to a peak value of the positive level and a second physical quantity corresponding to a peak value of the negative level on a basis of the sensor signal waveform output by the sensor element.

2. The physical quantity detecting device according to claim 1, wherein
the estimating unit
includes a storage section that stores a first table of the first physical quantity corresponding to the peak value of the positive level of the sensor signal waveform and a second table of the second physical quantity corresponding to the peak value of the negative level of the sensor signal waveform,
estimates the first physical quantity by applying the peak value of the positive level of the sensor signal waveform output by the sensor element to the first table stored by the storage section, and
estimates the second physical quantity by applying the peak value of the negative level of the sensor signal waveform output by the sensor element to the second table stored by the storage section.

3. The physical quantity detecting device according to claim 1, wherein
the sensor element is a strain sensor.

4. The physical quantity detecting device according to claim 1, wherein
the estimating unit makes a temperature correction to the peak value of the positive level and the peak value of the negative level of the sensor signal waveform output by the sensor element.

5. The physical quantity detecting device according to claim 1, wherein
the estimating unit includes two independent blocks that respectively estimate the first physical quantity and the second physical quantity.

6. The physical quantity detecting device according to claim 1, wherein
the sensor element
is disposed in a tire,
outputs the peak value of the positive level of the sensor signal waveform in a state in which the tire is in ground contact with a road surface, and
outputs the peak value of the negative level of the sensor signal waveform at a moment that the tire comes into ground contact with or separates from the road surface.

7. The physical quantity detecting device according to claim 1, wherein
the first physical quantity is a wear amount, and
the second physical quantity is a load weight.

8. The physical quantity detecting device according to claim 2, wherein
the physical quantity detecting device makes the sensor element output the sensor signal waveform under conditions of predetermined parameters corresponding to the first table and the second table.

9. The physical quantity detecting device according to claim 2, wherein
the physical quantity detecting device makes the sensor element output the sensor signal waveform under conditions under which at least an air pressure, a velocity, and a temperature as parameters of mixed-in signals mixed in the sensor signal waveform are restricted to predetermined ranges as conditions of predetermined parameters corresponding to the first table and the second table.

10. The physical quantity detecting device according to claim 1, wherein
the sensor element is disposed in a tire, and
the estimating unit obtains a temperature of the tire.

11. The physical quantity detecting device according to claim 1, wherein
the sensor element is disposed in a tire, and
the estimating unit obtains a velocity by dividing an outer circumference of the tire by an output cycle of the sensor signal waveform.

12. The physical quantity detecting device according to claim 1, wherein
the sensor element is disposed in a tire, and
the estimating unit obtains an air pressure of the tire.

13. The physical quantity detecting device according to claim 1, comprising:
a warning processing unit that distinguishes a range of the first physical quantity or the second physical quantity in a plurality of stages, and warns of a state in each stage.

14. The physical quantity detecting device according to claim 1, wherein
the sensor element is disposed at a center in a tire width direction on an inner circumferential side of a tire.

15. The physical quantity detecting device according to claim 1, wherein
the sensor element
is a strain sensor including a plurality of detecting units arranged in a plurality of rows and a plurality of columns in an X-direction and a Y-direction orthogonal to each other, and
is disposed in a tire such that either the X-direction or the Y-direction in which at least two detecting units are arranged side by side to produce output is set along a rotational direction of the tire.
